(19) United States
(12) Patent Application Publication
(10) Pub. No.: US 2017/0090025 A1
(43) Pub. Date: Mar. 30, 2017

(54) METHOD FOR LOCALISING SCATTERING ELEMENTS IN A 3D ENVIRONMENT

(71) Applicant: KABUSHIKI KAISHA TOSHIBA, Tokyo (JP)

(72) Inventor: Stephen WANG, Bristol (GB)

(21) Appl. No.: 15/125,305

(22) PCT Filed: May 21, 2015
(86) PCT No.: PCT/GB2015/051498

§ 371 Date: Sep. 12, 2016

(30) Foreign Application Priority Data
May 23, 2014 (GB) 1409269.6

(51) Int. Cl. G01S 13/46; G01S 7/41; G01S 13/00

(52) U.S. Cl. CPC G01S 13/46; G01S 13/003; G01S 7/414; G01S 2013/468

(57) ABSTRACT

A method of localising one or more scattering elements in a 3D environment, comprising (i) receiving, at an array of antennas, a signal sent from a transmitter and scattered towards the array by one or more scattering elements in the environment, (ii) modelling the signal as detected at each one of the antennas as a sum of individual signals scattered by the respective scattering elements, and (iii) collectively analysing the signals detected at each one of the antennas to identify the number and location(s) of the one or more scattering elements in the environment.

### FIELD

Embodiments described herein relate to systems and methods for localising scattering elements in a 3D environment.

### BACKGROUND

Conventional antenna-based localisation systems can be used to estimate the position of an object by exploiting geometric relationships between transmitting antennas and receiving antennas. Typically, in such systems, a number of transmitting antennas are distributed over a large area and arranged to form triangular constellations. An object's position can be estimated by equipping the object with a receiving antenna and comparing the properties of signals received by the receiving antenna from the different transmitting antennas. The properties of the received signals may include, for example, Time of Arrival (ToA), Time Difference of Arrival (TDoA), Received Signal Strength (RSS) and Angle of Arrival (AoA). By comparing the signals received from each transmitting antenna, the receiving antenna can determine its relative proximity to each transmitting antenna and in turn determine its coordinates in 3D space.

The conventional systems described above have a number of drawbacks, however. When using ToA measurements, for example, synchronization among all the units (transmitters, receivers) is essential and can be difficult and costly to achieve for wireless systems. Moreover, ToA estimates are obtained using two-way ranging which requires that all the units in the system are transceivers, which can increase the overall cost and complexity.

In the case of TDoA, only the transmitters need be synchronised and the receiver does not need to know the actual time of transmission. However, the presence of clock bias introduces an extra unknown to the system, which needs to be cancelled out. RSS measurements require accurate power value measurements and are more suitable for simple channel conditions and short distance scenarios.

The joint use of AoA and timing-based or RSS-based technologies requires dedicated complicated antenna array systems. In addition, the presence of dense scatterers in indoor channels introduces extra challenges in terms of estimation accuracy. RSS-based location fingerprinting technology depends heavily on the number of/distribution of survey points and requires a calibration process to understand the measured environment. This technique is very sensitive to environmental changes which are inevitable in most of indoor scenarios.

In addition to the specific issues described above, these conventional methods all have the further drawback that there is a need to equip the actual object in question with an antenna.

### BRIEF DESCRIPTION OF FIGURES

Embodiments of the invention will now be described by way of example with reference to the accompanying drawings in which:

FIG. 1 shows an example of a receiver for localising a scatterer in a 3D environment, according to an embodiment;

FIG. 2 shows an example of a simulated 3D environment, in which there are 3 objects present that act to scatter light from a transmitter towards a receiver array.

FIG. 3 shows a flow-chart of steps used to localise objects in a 3D environment, according to an embodiment;

FIG. 4 shows a flow-chart of steps used to group scattering elements into clusters in order to identify the location of objects in the 3D environment, according to an embodiment;

FIG. 5 shows examples of channel parameters determined for a particular scattering element, according to an embodiment;

FIG. 6 shows a test environment in which an embodiment was used to determine the location of scattering elements in a room containing different objects;

FIG. 7 shows channel parameter estimation results from measurements conducted in the test environment of FIG. 6;

FIG. 8 shows a comparison between the estimated locations of clusters of scatterers in the test environment of FIG. 6 when adding/removing certain objects from the test environment;

FIG. 9 shows top and side views of the estimated locations of clusters of FIG. 8, for the case in which the additional objects were absent from the test environment; and

FIG. 10 shows top and side views of the estimated locations of clusters of FIG. 8, for the case in which the additional objects were present in the test environment.

### DETAILED DESCRIPTION

According to a first embodiment, there is provided a method of localising one or more scattering elements in a 3D environment, comprising:
(i) receiving, at an array of antennas, a signal sent from a transmitter and scattered towards the array by one or more scattering elements in the environment;
(ii) modelling the signal as detected at each one of the antennas as a sum of individual signals scattered by the respective scattering elements; and
(iii) collectively analysing the signals detected at each one of the antennas to identify the number and location(s) of the one or more scattering elements in the environment.

In some embodiments, the step of collectively analysing the signals detected at each one of the antennas comprises determining one or more channel parameters associated with each scattering element, the channel parameters including:
a time of arrival of the signal scattered by the respective scattering element at a given point on the antenna array;
a direction in which the signal scattered by the respective scattering element is incident at the given point of the antenna array;
a distance between the respective scattering element and the given point of the antenna array; and
the complex attenuation of the signal scattered by the respective scattering element.

In some embodiments, the individual signals scattered by the respective scattering elements are modelled as being non-planar across the face of the antenna array.

In some embodiments, for each antenna, the signal detected at that antenna is modelled as being a sum of signals that have been scattered from the same scattering elements as for the other antennas.

In some embodiments, the method further comprises:
(iv) clustering the identified scattering elements into one or more clusters, each cluster of scattering elements defining the estimated location of an object in the environment.

In some embodiments, the scattering elements are clustered by considering likely properties of objects in the environment. The properties may include the likely shape and/or size of the objects in the environment. The scattering elements may be clustered by identifying scattering elements whose locations relative to one another are consistent with objects having those properties.

In some embodiments, the method comprises forming a plurality of different possible cluster arrangements by clustering different groups of scattering elements, and using a selection criterion for selecting one of the arrangements to use for estimating the location of objects in the environment. The selection criterion may be based on the size of the individual clusters and the distance between the clusters in each arrangement.

In some embodiments, the steps (i) to (iv) are repeated at intervals in order to track the movement of objects in the environment over time.

In some embodiments, the array of antennas is configured to act as a both a receiver and transmitter. On establishing the location of one or more of the objects, the array may transmit data in the direction of the object. The data may be transmitted towards the object by beamforming multiple ones of the antennas in the array.

In some embodiments, the method comprises filtering the received signals based on wavelength, wherein the signals that are collectively analysed are those having a specific band of wavelengths. The band of wavelengths may be selected based on the size of objects in the environment that it is desired to localise.

In some embodiments, the method comprises transmitting the signal from the transmitter into the environment. The wavelength of the transmitted signal may be selected based on the size of objects in the environment that it is desired to localise.

According to a second embodiment, there is provided a system for localising one or more scattering elements in a 3D environment, the system comprising:
a receiver comprising an array of antennas configured to receive signals sent from a transmitter and scattered towards the receiver by one or more scattering elements in the environment; and
a processor for collectively analysing the signals detected at each one of the antennas to identify the number and location(s) of the one or more scattering elements in the environment, the signal detected at each one of the antennas being modelled as a sum of individual signals scattered by the respective scattering elements.

In some embodiments, the array of antennas is a planar array.

In some embodiments, at least one of the antennas in the array is configured to function as both a transmitter and a receiver.

In some embodiments, the receiver is a MIMO antenna.

Embodiments described herein utilise the fact that, where a large scale antenna-matrix receiver is employed for detecting high frequency band signals, a spherical (i.e. non-planar) wavefront may be observed at the receiver, with the angle of arrival of the incident signal being different for different antennas in the array. As a consequence, it becomes possible to exploit different characteristics of the incident signal for object localisation; an object or item can be localised by exploiting the difference in channel parameters received at those various antenna elements. In particular, a user or object can be localised as a ‘cluster of scatterers’, whereby the user/object need not themselves be equipped with an active positioning device (e.g. transmitter/receiver) but can instead simply serve as a scatterer for scattering signals emitted from another source. It is also unnecessary to perform synchronization procedures such as those as described above in relation to ToA and TDoA methods. Exploiting radiation patterns and their shifting of antennas in the system can further enhance the performance.

Embodiments described herein are compatible with communication systems in which the receiver will function not only as a means for localising objects in the vicinity, but also for interpreting/relaying actual data content that is encoded in transmissions sent from the transmitter (or indeed, any other transmitter). Such data content may, for example, comprise video or audio data packets, or any other information that a first user at the transmitter end wishes to convey to a second user at the receiver end. The receiver may form part of a larger signal processing chain including e.g a signal demodulator and/or decoder for decoding the data encoded in the signals received at the antennas in the array. The estimation of the channel parameters, and subsequent use of those parameters for localisation of objects in the environment, may be carried out using those same transmitted signals on which the data content is encoded.

The use of large scale antenna matrix receivers (e.g. massive MIMO antenna arrays) and high frequency signals are both features envisaged for use in 5G communication systems. Embodiments described herein are, therefore, compatible with 5G communication systems, in which the aperture of the receiver antenna array is expected to be much larger than the wavelength of the used carrier frequencies. Indeed, embodiments described herein can be implemented using the same hardware as envisaged in a 5G antenna systems and serve to further enhance the overall functionality of those systems.

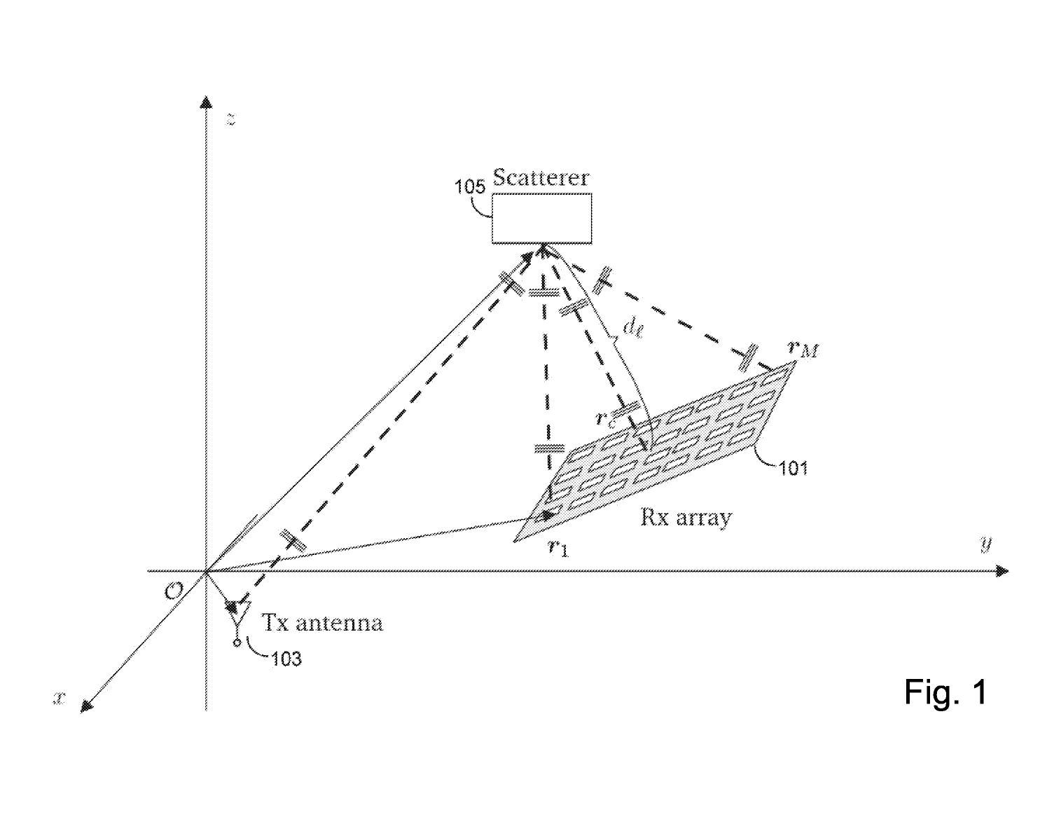

FIG. 1 shows an example of a receiver 101 according to an embodiment. The receiver forms part of a larger system that also includes a transmitter 103. For simplicity, in this example the transmitter in the communication system is equipped with a single antenna only. The receiver 101 comprises an array of tightly-spaced antennas that are collectively used to determine the location of an object 105 by detecting radio-wave frequency signals that are transmitted from the transmitter 103 and scattered by the object 105. The symbols shown in FIG. 1 define the following variables:

r₁: the location of the first Rx antenna in the (x, y, z) coordinate system
r_{M}: the location of the M^{th} Rx antenna in the (x, y, z) coordinate system
r_{c}: the location of the centre of the Rx antenna array in the (x, y, z) coordinate system

For the system considered here, the path of a signal scattered by an object towards the receiver array can be characterised by the following parameters:

τ: the delay or time of arrival of the signal at a given antenna in the array;
Ω: the direction in which the wave is incident on a given antenna in the array;
d: the distance between the scatterer and a given antenna in the array; and
α: the complex attenuation

Here, the parameter d is introduced to facilitate the localisation function. A single wave will exhibit a change in delay, distance and directions when observed by the respective antennas in the receiver 101. Thus, for a massive MIMO receiver, the channel parameters τ, Ω, d, α will not be constant when observed with different antenna elements in the receiver array.

A spherical wavefront based signal model can be used to describe the received signal at the m^{th} Rx antenna. Here, the transmitted signal is denoted by u(t). In the event that multiple propagation paths L exist (i.e. where there are L scatterers in the environment that may serve to scatter the transmitted signal towards the receiver), the received signal yₘ(t) at the m^{th} Rx antenna can be modelled as:

$${y}_{m} ( t ) = {\sum }_{l = 1}^{L} {α}_{l} u ( t - {τ}_{l} ) exp \{ j \frac{2 π}{λ} ( ‖ {r}_{m} - {r}_{c} - {d}_{l} {Ω}_{l} ‖ - {d}_{l} ) \} + {n}_{m} ( t ) .$$

where:
τₗ is the delay or time of arrival of the signal scattered by the l^{th} scatterer, as detected at the central antenna of the Rx antenna array;
Ωₗ is the direction in which the wave scattered by the l^{th} scatterer is incident on the central antenna of the Rx antenna array;
dₗ is the distance between the l^{th} scatterer and the central antenna of the Rx antenna array;
αₗ is the complex attenuation of the signal scattered by the l^{th} scatterer, as detected at the central antenna of the Rx antenna array;
nₘ(t) is the white Gaussian noise component observed at the m^{th} antenna;
∥.∥ defines the norm of the given argument; and
λ is the wavelength at the carrier frequency considered.

The problem is now to estimate the parameters of the L paths, i.e. to determine (αₗ, τₗ, Ωₗ, d₁) for each point in the environment l=1, . . . L that acts to scatter the signal from the transmitter to the receiver.

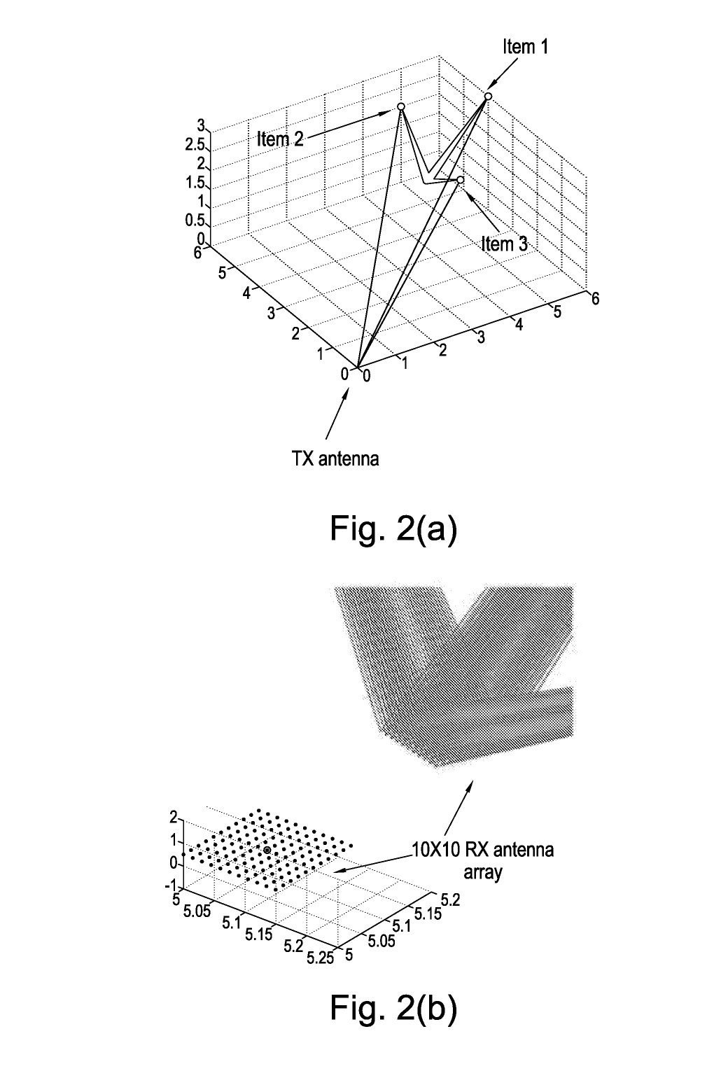

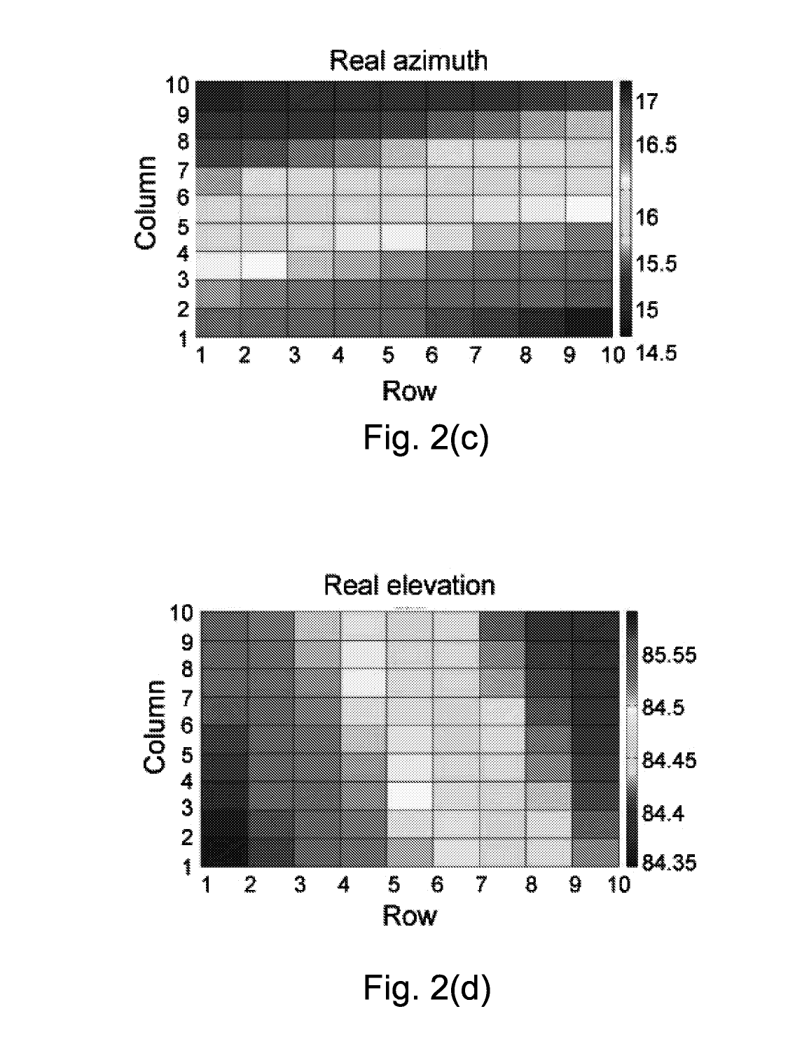

FIG. 2 shows an example of a simulated 3D environment, in which there are 3 objects present that act to scatter light from a transmitter towards a receiver array. Here, each object is assumed to comprise a single scattering point and the receiver array comprises a 10×10 matrix of antennas. The coordinate positions of the transmitter, scatterers and receiver are shown in FIG. 2(a), whilst FIG. 2(b) shows the scattered signals incident on the receiver array. FIGS. 2(c) and 2(d) show, respectively, values for azimuth and elevation as would be seen at each antenna in the receiver array (it will be understood that the channel parameter Ω defines both the value of the azimuth and elevation). Together with the distance parameter d described above, these values can be collectively analysed to identify the origin of the scattered signals and so localise the objects within the 3D environment.

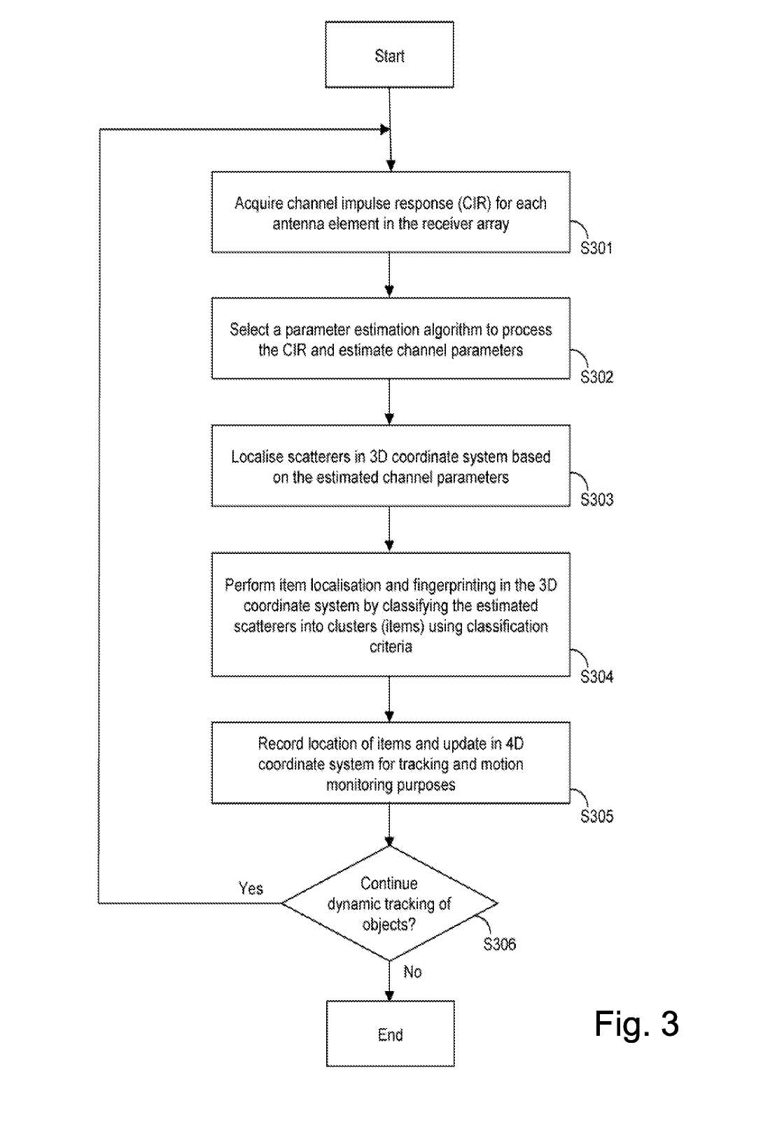

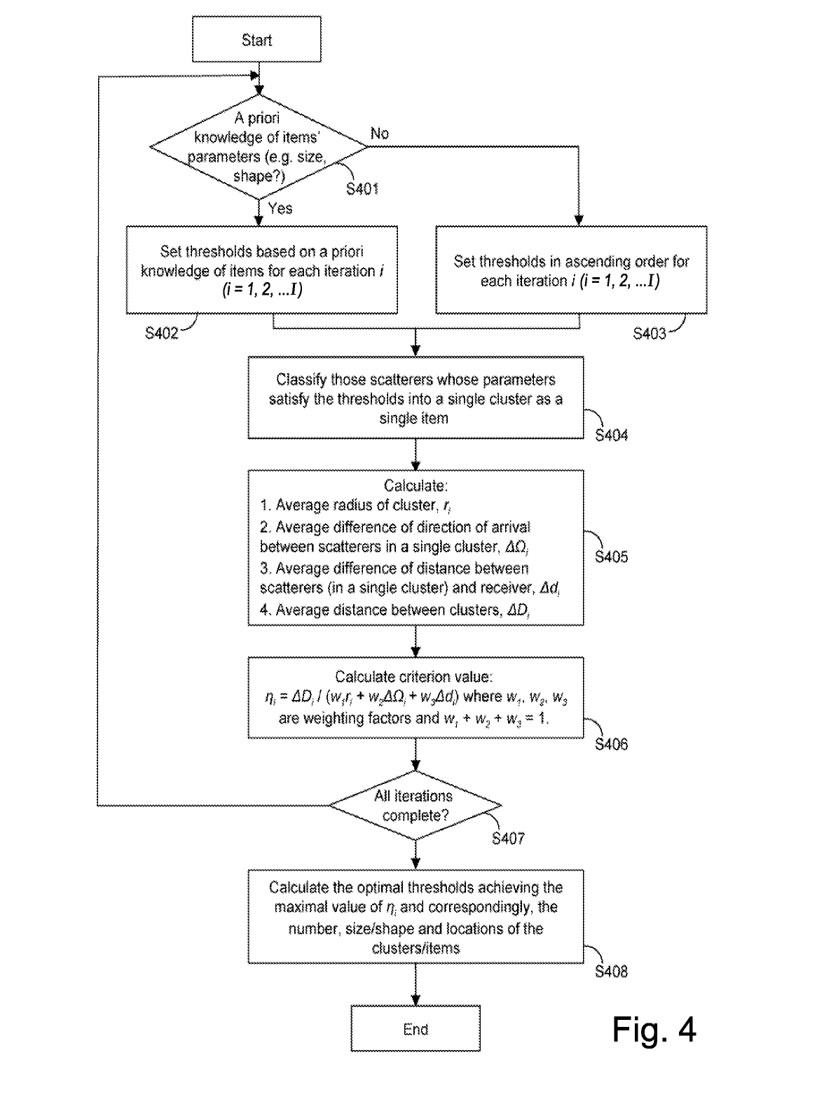

An example of how the localisation process may be implemented will now be discussed with reference to the flow-charts of FIGS. 3 and 4.

In step S301 of FIG. 3, the channel impulse response is determined for each antenna element of the receiver antenna matrix. Any one of a number of methods known in the art can be used to obtain the impulse responses. For example, the impulse response for a particular antenna element may be determined by using an m-sequence signal of P-N train pulses and sliding correlator.

In order to localise scatterers in the system, the channel parameters need to be estimated from the impulse response. In particular, the time of arrival (i.e., delay) of the path τ; the direction of arrival Ω; and the distance d between the scatterer interacting with the wave and the centre of the receiver antenna matrix, should be estimated for localisation purposes. One of a number of different channel parameter estimation methods can be selected for this purpose (step S302).

In one embodiment described herein, a low-complexity approximation of the Maximum Likelihood estimation method is used for estimating the channel parameters; this algorithm is referred to as the spherical wavefront based Space-Alternating Generalized Expectation-maximization (SAGE) algorithm. This algorithm can be used to estimate the channel parameters for individual paths by using an iterative approach. It can be shown that the estimates for the channel parameters τₗ, dₗ, and Ωₗ associated with a particular scatterer l can be calculated as follows:

$${\hat{τ}}_{l}^{i} = arg { max}_{{τ}_{l}} {\vert {\sum }_{m = 1}^{M} \int , {r}_{l , m} ( t ) {u}^{*} ( t - {τ}_{l} ) exp \{ - j \frac{2 π}{λ} ( ‖ {r}_{m} - {r}_{c} - {\hat{d}}_{l}^{i - 1} {\hat{Ω}}_{l}^{i - 1} ‖ - {\hat{d}}_{l}^{i - 1} ) \vert \} d t \vert}^{2}$$

$${\hat{Ω}}_{l}^{i} = arg {max}_{{Ω}_{l}} {\vert {\sum }_{m = 1}^{M} \int , {r}_{l , m} ( t ) {u}^{*} ( t - {\hat{τ}}_{l}^{i} ) exp \{ - j \frac{2 π}{λ} ( ‖ {r}_{m} - {r}_{c} - {\hat{d}}_{l}^{i - 1} {Ω}_{l} ‖ - {\hat{d}}_{l}^{i - 1} ) \vert \} d t \vert}^{2} \\ {\hat{d}}_{l}^{i} = arg {max}_{{d}_{l}} {\vert {\sum }_{m = 1}^{M} \int , {r}_{l , m} ( t ) {u}^{*} ( t - {\hat{τ}}_{l}^{i} ) exp \{ - j \frac{2 π}{λ} ( ‖ {r}_{m} - {r}_{c} - {d}_{l} {\hat{Ω}}_{l}^{i} ‖ - {d}_{l} ) \} d t \vert}^{2}$$

It will be understood that the SAGE algorithm is referred to here by way of example only and other suitable estimation algorithms, as known in the art, may also be used for this step. Examples of such estimation algorithms include the well-known RIMAX, MUSIC, and ESPRIT algorithms, themselves being widely used in current channel parameter estimation, in the assumption of a planar wave.

In step S303, the location of scatterers in the 3D coordinate system is determined based on the estimated channel parameters (e.g., direction of arrival Ωₗ and distance dₗ from scatterers to the receiver antenna matrix).

An object or item can be considered as comprising a cluster of scatterers in the 3D environment. In order to localise these items (i.e. clusters of scatterers), channel measurements are conducted at multiple snapshots in time. In step S304, the locations of scatterers extracted from CIRs resulting from multiple measurement snapshots in the same environment are jointly analysed and clusters of scatterers are then identified. To do so, a number of thresholds are defined based on either a priori knowledge of items' parameters or estimates of the items' parameters (where the items' parameters refer to the size/shape etc of those items). An iterative approach is then used to obtain the optimal thresholds under a clustering criterion. In one example, the clustering criterion is that the ratio between the inter-cluster distance and the average intra-cluster spread should be as large as possible.

Once clusters of scatterers are identified, the statistics of the parameters characterizing the clusters of scatterers can be calculated and to be used to construct a stochastic channel model.

FIG. 4 provides a more detailed example of how the clustering of scatterers and item localisation shown in step S304 of FIG. 3 may be implemented. It will be understood that FIG. 4 is provided by way of example only, and different scatterers clustering and item localisation algorithms can be employed in said system using proposed localisation technology.

As will be seen, the steps shown in FIG. 4 comprise an iterative process that is repeated a pre-determined number of/times. Starting at step S401, a check is made as to whether the receiver has access to a priori knowledge of parameters of the items that it is seeking to localise in the 3D environment, where those parameters include, for example, the size and/or shape of the items. If such information is available, the method proceeds to step S402, in which thresholds for those parameters are set based on the information. If no such information is available, the method proceeds to step S403, where thresholds are estimated based on typical expected values for the parameters (in essence, the thresholds defined in step S403 will be broader in range than those defined in step S402, to take account of the larger uncertainty in the likely size/shape etc of the items in the environment).

In step S404, individual scatterers are clustered by identifying those scatterers that when grouped together define objects having properties (e.g. size) that are consistent with the thresholds defined in steps S402 or S403; the clustered scatterers are then classed as single items/objects.

In step S405, the following values are calculated, based on the identified clusters:

1. Average radius of the clusters, rᵢ;

2. Average difference of direction of arrival between scatterers in a single cluster, ΔΩᵢ;

3. Average difference of distance between scatterers (in a single cluster) and receiver, Δdᵢ,

4. Average distance between clusters, ΔDᵢ

Next, in step S406, a criterion factor ηᵢ is determined, where:

ηᵢ=ΔDᵢ/(w₁rᵢ+w₂ΔΩᵢ+w₃Δdᵢ;

and w₁, w₂, and w₃ are weighting parameters, which can be manually selected. The criterion value defines the ratio between the inter-cluster distance and the average intra-cluster spread.

In step S407, a check is made as to whether further iterations are to be run for the algorithm. If so, the method returns to step S401 and new thresholds are chosen before repeating steps S404 to S406. For successive iterations, the thresholds can be set in ascending order, descending order or any random order. Once the full number of iterations/has been run, the values of the criterion factor ηᵢ determined at each iteration are compared with one another in order to determine the thresholds values that have yielded the highest value for the criterion factor ηᵢ. Having identified those threshold values, the most likely number, size, shape and location of the clusters in the 3D environment can be determined (step S408).

Returning to FIG. 3, once the clusters have been identified and localised as described above, the method continues with Step S305. Here, the location of items in the environment is updated in order to provide a tracking service on non-static items. In so doing, it becomes possible to extend the 3D localisation of objects to a 4D localisation and tracking service. It will be understood that step S305 is optional and is not essential to the process of actually determining the location of the items per se. The location update process can be managed in a periodical update mode or an event-trigger mode that is customised and reconfigurable depending on the characteristics of the targeted items.

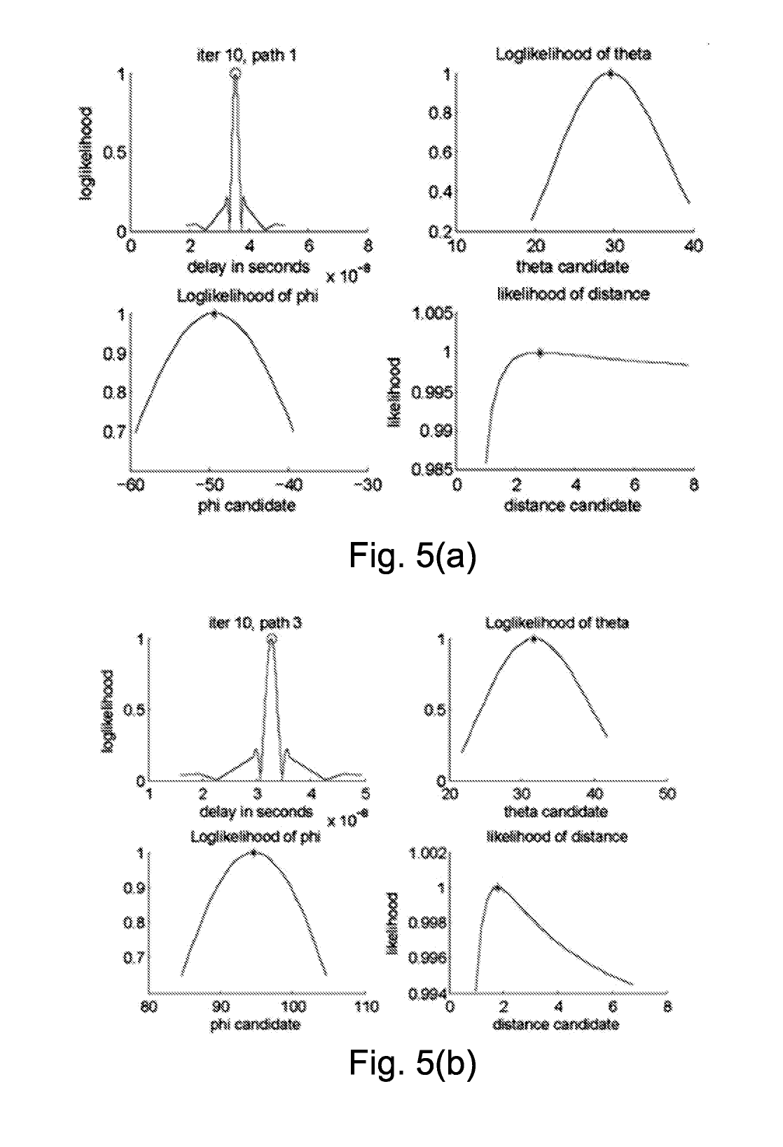

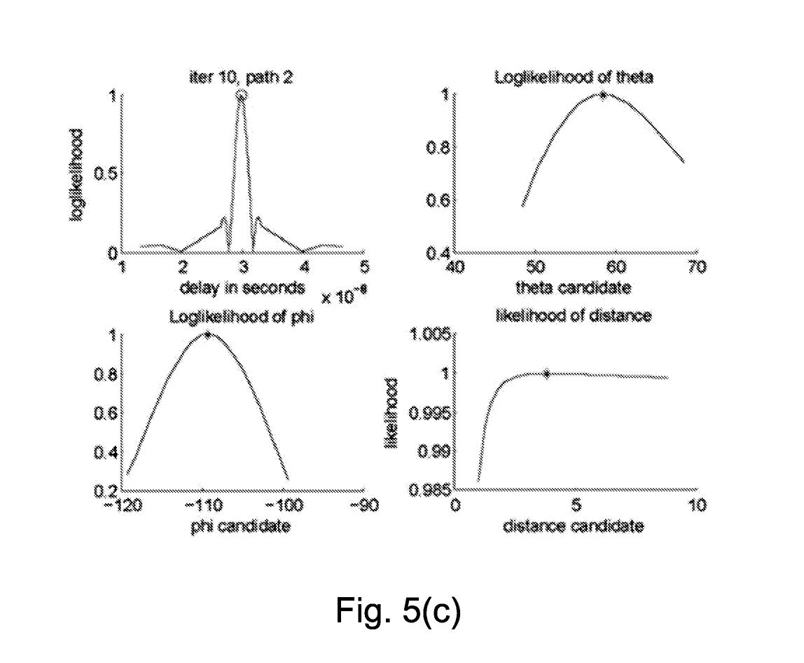

FIG. 5 shows results of using the parameter estimation process and item localisation results for the simulated environment of FIG. 2. Specifically, FIG. 5(a) shows estimates for the channel parameters defining the position of the first object of FIG. 2, FIG. 5(b) shows estimates for the channel parameters defining the position of the second object and FIG. 5(c) shows estimates for the channel parameters defining the position of the third object (note that here, the values of Theta and Phi are obtained from Ω). These results are summarised in Tables 1 to 3 below, where they are compared against the actual true values of each of those parameters. As can be seen, there is good agreement between the estimates and the actual values for each parameter.

TABLE 1
Item localisation results for object 1 in the scenario shown in FIG. 2.

| | Distance/m | Theta/° | Phi/° | Delay | Amplitude |
|---|---|---|---|---|---|
| True value | 2.874 | 29.57 | −49.29 | 3.5615e−8 | 1.00 + i0.00 |
| Estimated | 2.875 | 29.56 | −49.29 | 3.5614e−8 | 1.00 + i0.01 |
| value | | | | | |

TABLE 2
Item localisation results for object 2 in the scenario shown in FIG. 2.

| | Distance/m | Theta/° | Phi/° | Delay | Amplitude |
|---|---|---|---|---|---|
| True value | 3.822 | 58.45 | −109.27 | 2.9819e−8 | 1.00 + i0.00 |
| Estimated | 3.823 | 58.45 | −109.27 | 2.9819e−8 | 0.99 + i0.00 |
| value | | | | | |

TABLE 3
Item localisation results for object 3 in the scenario shown in FIG. 2.

| | Distance/m | Theta/° | Phi/° | Delay | Amplitude |
|---|---|---|---|---|---|
| True value | 1.764 | 31.74 | −94.64 | 3.2753e−8 | 1.00 + i0.00 |
| Estimated | 1.764 | 31.75 | −94.63 | 3.2754e−8 | 0.99 + i0.00 |
| value | | | | | |

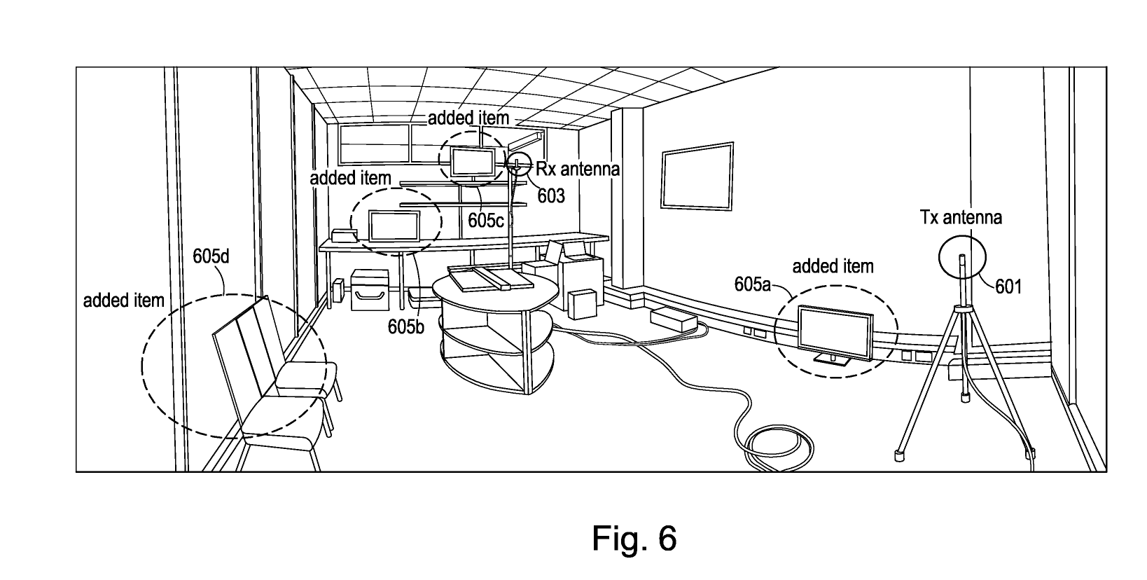

In order to further test the method of the present embodiment, a scenario was set up in which a single antenna transmitter 601 and 11×11 receiver antenna matrix were located in a room, together with 4 added scattering items in the form of 3 TVs and 1 metal plane. FIG. 6 shows a view of the room, in which the position of the transmitter 601, receiver 603 and scattering items 605a-d has been indicated. Measurements were taken at the receiver in both the presence and absence of the 4 added scattering items.

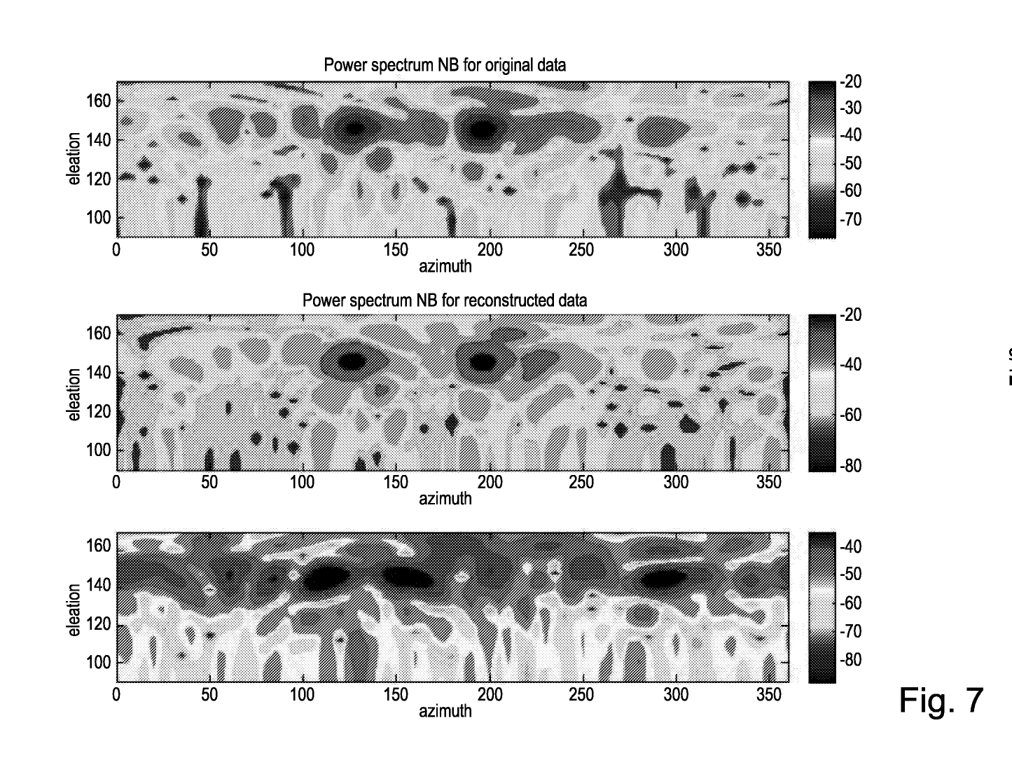

FIG. 7 shows the parameter estimation results using measurement data collected from the receiver in FIG. 6 and comparison of the Direction of Arrival (DoA) power spectrum calculated based on the original received data (top), the reconstructed data (middle) and their difference (bottom). Frequency ranges were from 9251 MHz to 9750 MHz.

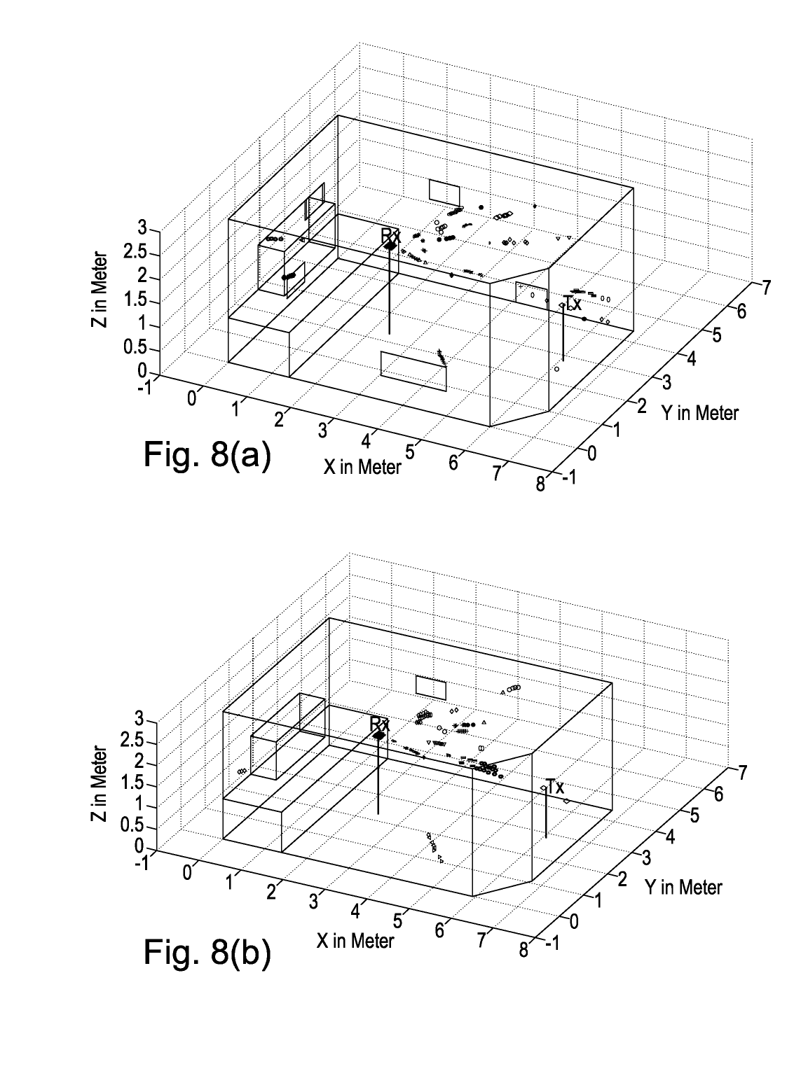

FIGS. 8(a) and 8(b) show a comparison of the estimated locations of clusters of scatterers for the respective cases in which the 4 additional scatterers were present and absent from the room of FIG. 6. By using the aforementioned item localisation algorithm, 16 clusters were found to be present in FIG. 8(a) and 13 clusters were found to be present in FIG. 8(b), both being obtained from the 10 measurement snapshots (in order to visualise the clusters, the scattering elements within a respective cluster are identified in FIGS. 8(a) and 8(b) by using the same symbol for each scattering element in that cluster). Most of the identified scatterers could be associated with their counterparts in reality. For example, in both cases, a common cluster of scatterers is found to correspond to the TV screen hanging on the wall to the right hand side of the room; in addition, in both cases another common cluster of scatterers is observable on the left hand wall.

The difference between the cluster locations of FIGS. 8(a) and 8(b) can also be reasonably related to the presence/absence of the 4 additional scatterers; for example, referring to FIG. 8(a), two well-separated scatterer clusters are observed to cover parts of two TV screen located on the shelf close to the wall opposite to the transmitter. These clusters of scatterers are not present in FIG. 8(b); this is consistent with the fact that the TV was absent in that scenario and the shelf was, therefore, empty. In both FIGS. 8(a) and (b), clusters of scatterers are observed between the receiver and the wall to the right. It is postulated that these scatterers exist in the vicinity of the positioner below the receiver array, and surrounding an air conditioner which is installed on the ceiling above the array.

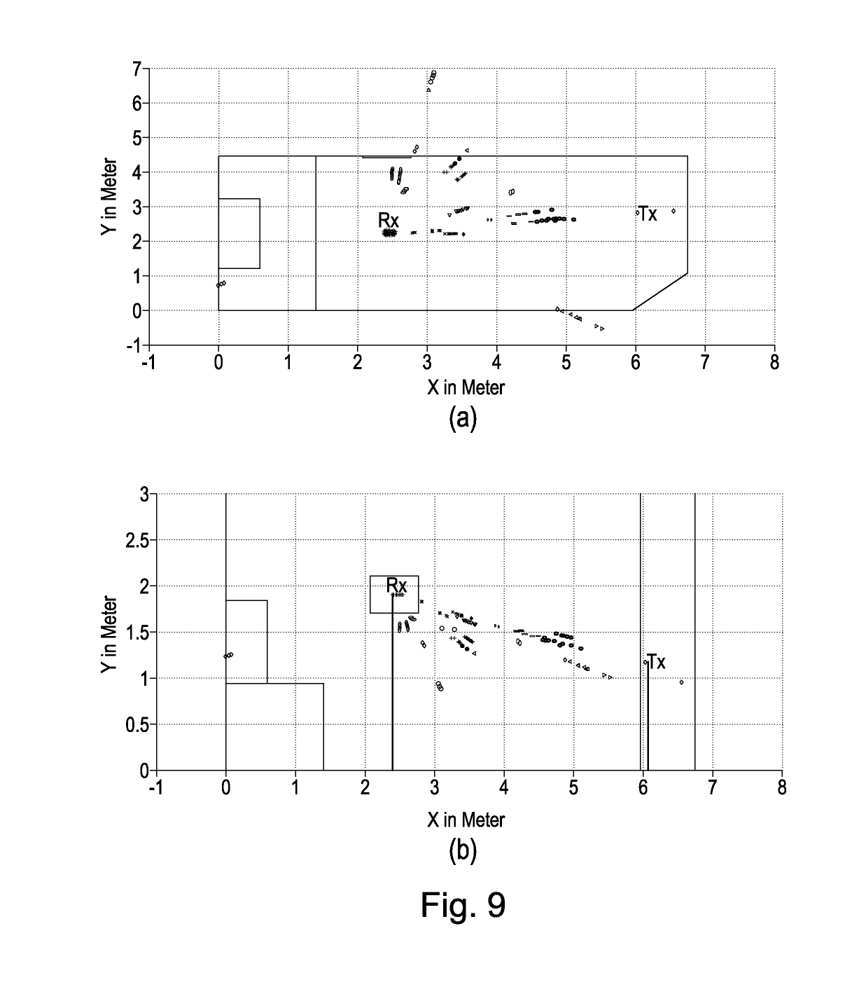

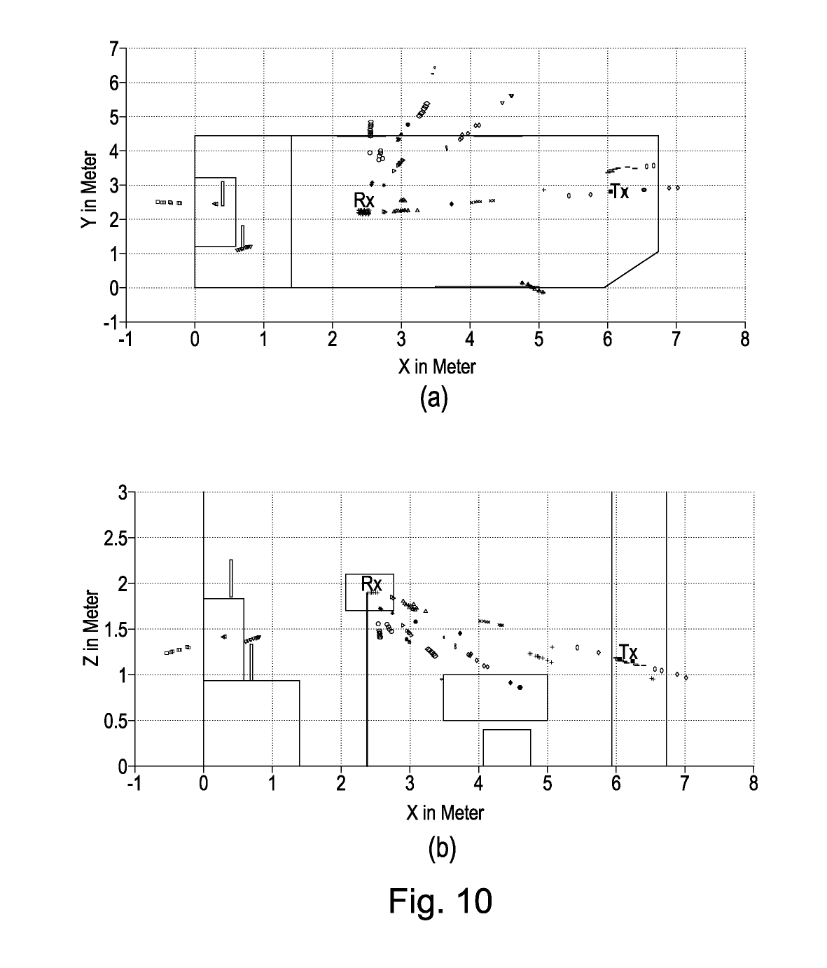

The difference between the estimated locations of scatterers in FIGS. 8(a) and 8(b) is further demonstrated by reference to FIGS. 9 and 10. FIGS. 9(a) and 9(b) show the view of FIG. 8(a) as seen from the top and side, respectively. FIGS. 10(a) and 10(b) meanwhile show the view of FIG. 8(b) as seen from the top and side, respectively. Together, these results demonstrate that the algorithm described herein can be used to successfully estimate the locations of scatterers within a 3D environment.

Thus, embodiments described herein provide a ‘cluster of scatterers’ based stochastic geometry spatial channel model and parameter estimation algorithm which are superior for reproducing the wideband high-frequency channel. Such a channel model provides a strong candidate for a 5G channel model in IEEE, 3GPP, IMT standards.

In some embodiments, the frequency of carrier signals transmitted by the transmitter and received at the receiver may be in excess of 5 GHz. It is desirable to include a large number of antennas in the receiver array; in some embodiments, the array may include 20 or more antenna elements, in some embodiments the array may include 50 or more antenna elements and in some embodiments the array may include 100 or more antenna elements. The spacing between the antenna elements in the array may be between 0.1 and 10 times the wavelength of the carrier signals that are transmitted from the transmitter and analysed upon receipt of the receiver. In some embodiments, the antenna spacing may be between 0.1 and 1 times the wavelength of the carrier signals. Increasing the overall number of antennas and selecting the antenna spacing in accordance with the wavelength of the carrier signals (where the wavelength itself may be selected based on the size of objects that it is desired to localise), can help improve performance in terms of localising the objects with greater accuracy.

In some embodiments, items/objects of interest may be provided with scattering-enhancing materials in order to increase the strength of scattered signals received from those items and help improve the estimation accuracy of channel parameters and the accuracy with which items are identified and localised.

In some embodiments, the receiver itself may function as a transmitter i.e. some or all of the antenna elements in the receiver array may also be capable of functioning as transmitters for use in transmitting data to a user's location. On determining the location of a particular object/item (which may, for example, coincide with a user's location), the receiver array may be reconfigured as a transmitter array, and used to transmit data to that location. The elements of the transmitter array may function collectively to beamform signals for directing data to the specific location in question. In one example, such a method could be used in a lecture/conference hall, whereby the receiver could be used to localise a speaker/lecturer and/or a person asking questions and a directional microphone could be steered towards that person in order help make their voice clear to the rest of the audience. Another example relates to users in a massive MIMO HetNet: here, an individual user could be localised using either a fixed transmitter or portable transmitter such as a user's mobile phone or other computing device and a massive MIMO configuration antenna matrix as a receiver, with the antennas of the receiver detecting signals emitted from the transmitter and scattered by the user. Having determined the individual's location based on the scattered signals, a subset of the MIMO antenna elements could then be selected/reselected from the massive MIMO antenna matrix and used to act as a personal/dedicated base station for that individual, taking into account the user's customised service requirements (e.g., QoS).

In some embodiments, the number and/or size and/or shape of the receiver/transmitter antenna can be reconfigurable to satisfy the various requirements of communication service and localisation service from time to time. Multiple antenna arrays can be employed as collaborative/relay antenna arrays in the system. The radiation patterns and pattern-shifting functions of the antenna elements can be exploited. The bandwidth and operation frequency of each antenna element may also be reconfigurable to further enhance the performance in terms of localising objects of different size.

In summary, embodiments described herein differ from conventional systems in a number of ways:

1. Using the proposed methods in massive MIMO systems, items to be localised do not themselves need to be equipped with any positioning device (transmitter/receiver).

2. The proposed embodiments can be implemented as add-ons to hardware designed for 5G communication systems, allowing such systems to provide both communication and localisation functions.

3. Embodiments can provide dynamic localising and tracking service on non-static items.

While certain embodiments have been described, these embodiments have been presented by way of example only, and are not intended to limit the scope of the invention. Indeed, the novel methods, devices and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the inventions.

1. A method of localising one or more scattering elements in a 3D environment, comprising:
(i) receiving, at an array of antennas, a signal sent from a transmitter and scattered towards the array by one or more scattering elements in the environment;
(ii) modelling the signal as detected at each one of the antennas as a sum of individual signals scattered by the respective scattering elements; and
(iii) collectively analysing the signals detected at each one of the antennas to identify the number and location(s) of the one or more scattering elements in the environment.

2. A method according to claim 1, wherein collectively analysing the signals detected at each one of the antennas comprises determining one or more channel parameters associated with each scattering element, the channel parameters including:
a time of arrival of the signal scattered by the respective scattering element at a given point on the antenna array;
a direction in which the signal scattered by the respective scattering element is incident at the given point of the antenna array;
a distance between the respective scattering element and the given point of the antenna array; and
the complex attenuation of the signal scattered by the respective scattering element.

3. A method according to claim 1, wherein the wavefronts of the individual signals scattered by the respective scattering elements are modelled as being non-planar across the face of the antenna array.

4. A method according to claim 3, wherein for each antenna, the signal detected at that antenna is modelled as being a sum of signals that have been scattered from the same scattering elements as for the other antennas.

5. A method according to claim 1, further comprising:
(iv) clustering the identified scattering elements into one or more clusters, each cluster of scattering elements defining the estimated location of an object in the environment.

6. A method according to claim 5, wherein the scattering elements are clustered by considering likely properties of objects in the environment.

7. A method according to claim 6, wherein the properties include the likely shape and/or size of the objects in the environment and the scattering elements are clustered by identifying scattering elements whose locations relative to one another are consistent with objects having those properties.

8. A method according to claim 7, comprising forming a plurality of different possible cluster arrangements by clustering different groups of scattering elements, and using a selection criterion for selecting one of the arrangements to use for estimating the location of objects in the environment.

9. A method according to claim 8, wherein the selection criterion is based on the size of the individual clusters and the distance between the clusters in each arrangement.

10. A method according to claim 5, wherein the steps (i) to (iv) are repeated at intervals in order to track the movement of objects in the environment over time.

11. A method according to claim 5, wherein the array of antennas is configured to act as a both a receiver and transmitter, and wherein, on establishing the location of one or more of the objects, the array transmits data in the direction of the object.

12. A method according to claim 11, wherein the data is transmitted towards the object by beamforming multiple ones of the antennas in the array.

13. A method according to claim 1, comprising filtering the received signals based on wavelength, wherein the signals that are collectively analysed are those having a specific band of wavelengths.

14. A method according to claim 13, wherein the band of wavelengths is selected based on the size of objects in the environment that it is desired to localise.

15. A method according to claim 1, further comprising transmitting the signal from the transmitter into the environment.

16. A method according to claim 15, wherein the wavelength of the transmitted signal is selected based on the size of objects in the environment that it is desired to localise.

17. A system for localising one or more scattering elements in a 3D environment, the system comprising:
a receiver comprising an array of antennas configured to receive signals sent from a transmitter and scattered towards the receiver by one or more scattering elements in the environment; and
a processor for collectively analysing the signals detected at each one of the antennas to identify the number and location(s) of the one or more scattering elements in the environment, the signal detected at each one of the antennas being modelled as a sum of individual signals scattered by the respective scattering elements.

18. A system according to claim 17, wherein the array of antennas is a planar array.

19. A system according to claim 17, wherein at least one of the antennas in the array is configured to function as both a transmitter and a receiver.

20. A system according to claim 17, wherein the receiver is a MIMO antenna.
